(19) United States
(12) Patent Application Publication
(10) Pub. No.: US 2019/0214747 A1
(43) Pub. Date: Jul. 11, 2019

(54) E - Z PULL BATTERY TERMINAL

(71) Applicants: DANNY A. KIRCHNAVY, SR., Oak Hills, CA (US); Helen Ann Kirchnavy, Oak Hills, CA (US); Curtis Mathew Kirchnavy, Hesperia, CA (US); Diane Lynn Kirchnavy, Hesperia, CA (US)

(72) Inventors: DANNY A. KIRCHNAVY, SR., Oak Hills, CA (US); Helen Ann Kirchnavy, Oak Hills, CA (US); Curtis Mathew Kirchnavy, Hesperia, CA (US); Diane Lynn Kirchnavy, Hesperia, CA (US)

(21) Appl. No.: 16/171,001

(22) Filed: Oct. 25, 2018

Related U.S. Application Data
(60) Provisional application No. 62/707,294, filed on Oct. 30, 2017.

(51) Int. Cl. H01R 11/28

(52) U.S. Cl. CPC H01R 11/282

(57) ABSTRACT

A method and apparatus for removing a battery terminal without damaging the battery post.

### SUMMARY OF THE INVENTION

This present invention relates generally to battery cable ends for top post batteries. Battery cable end is utilized in the general manner but the removal mechanism, by using the E-Z PULL BATTERY TERMINAL, makes battery removal easy causing no damage.

The threaded mechanism is used for easy removal with no damage versus the practice of pushing, pulling, prying with pliers, screwdrivers, hammer or any foreign object. Your typical battery cable end is not equipped with any kind of mechanism to help in the aid of removal of corroded or frozen-on battery cables. The modified battery cable end described and shown in drawings will simplify the removal of all top post battery ends.

### BRIEF DESCRIPTION OF THE DRAWINGS

FIG. 1 is a perspective view of the battery cable end with modifications;

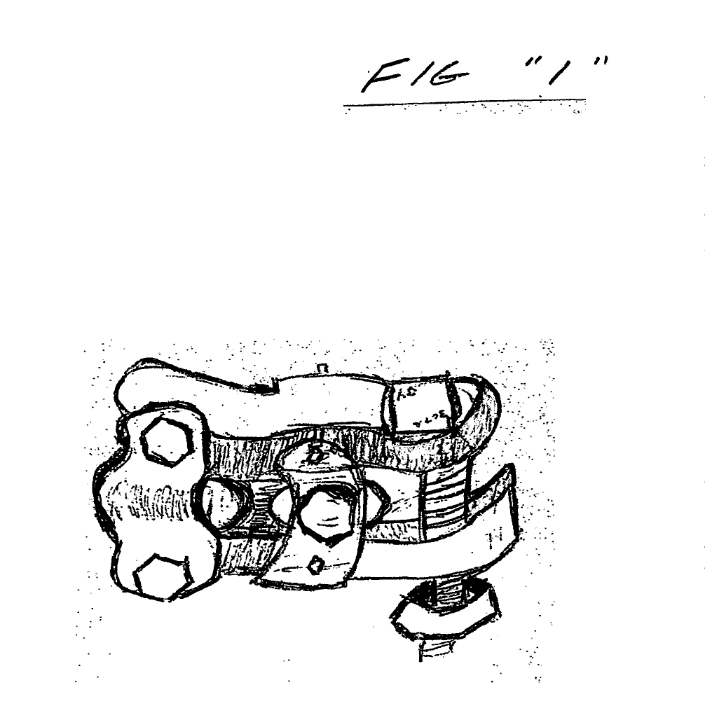

FIG. 2 is a perspective bottom view of the battery cable end modification;

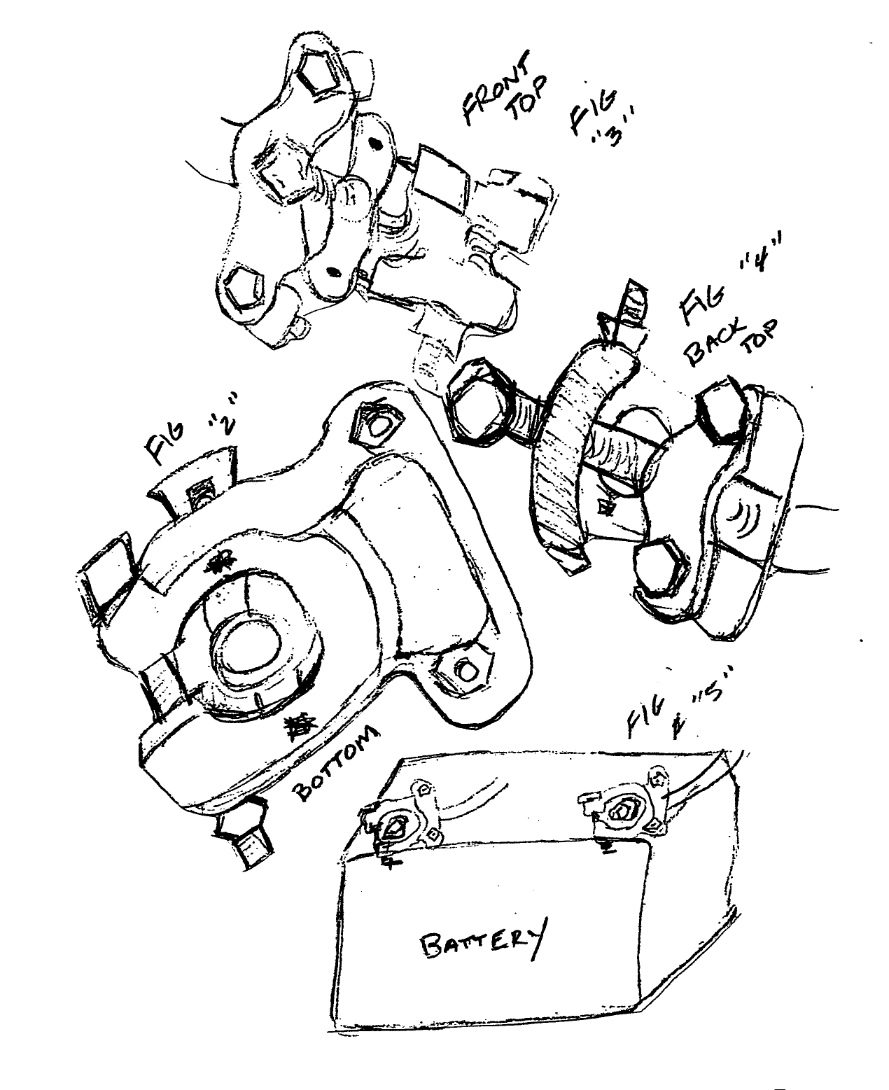

FIG. 3 is a perspective front top view of the battery cable end modification;

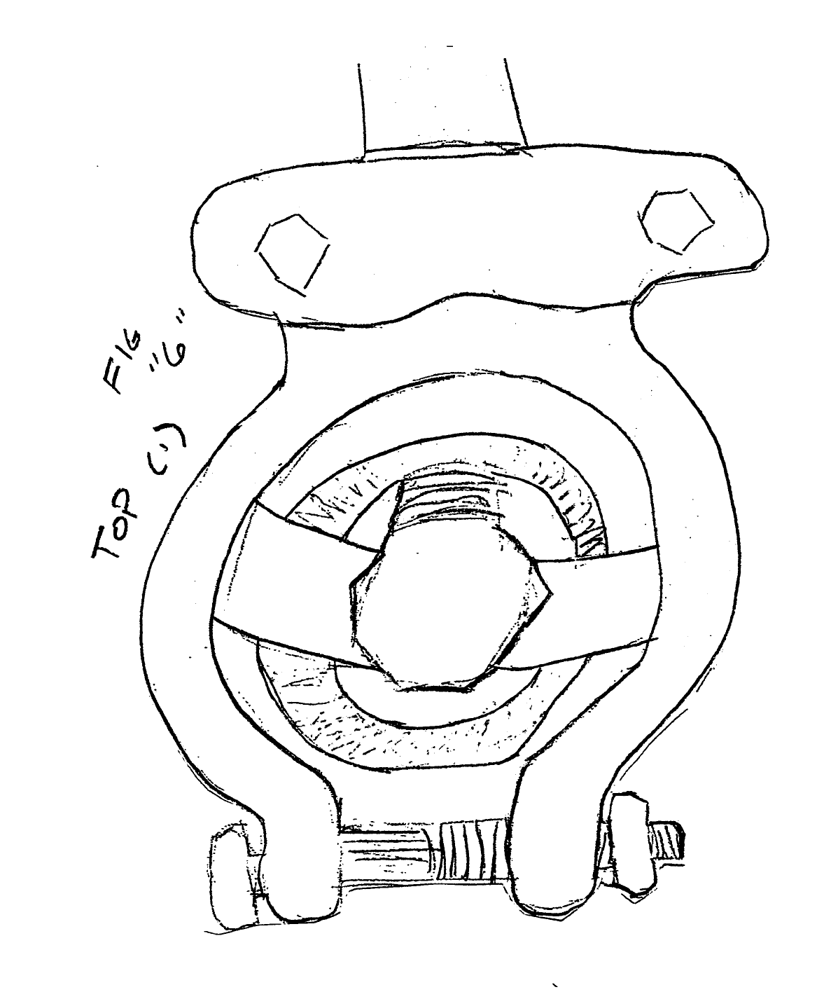

FIG. 4 is a perspective back top view of the battery cable end modification;

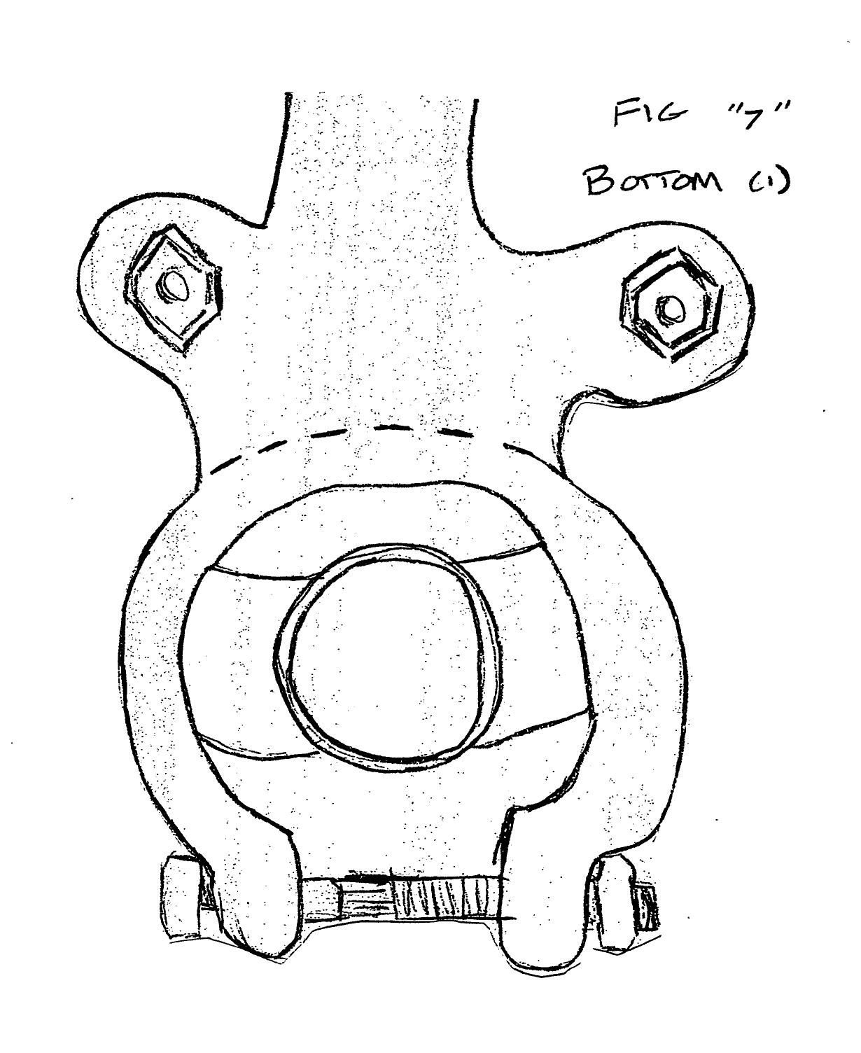

FIG. 5 shows cable ends mounted on a battery, also viewed as sheet 8 of 8 is a larger view of the battery cable mounted on a battery labeled side;

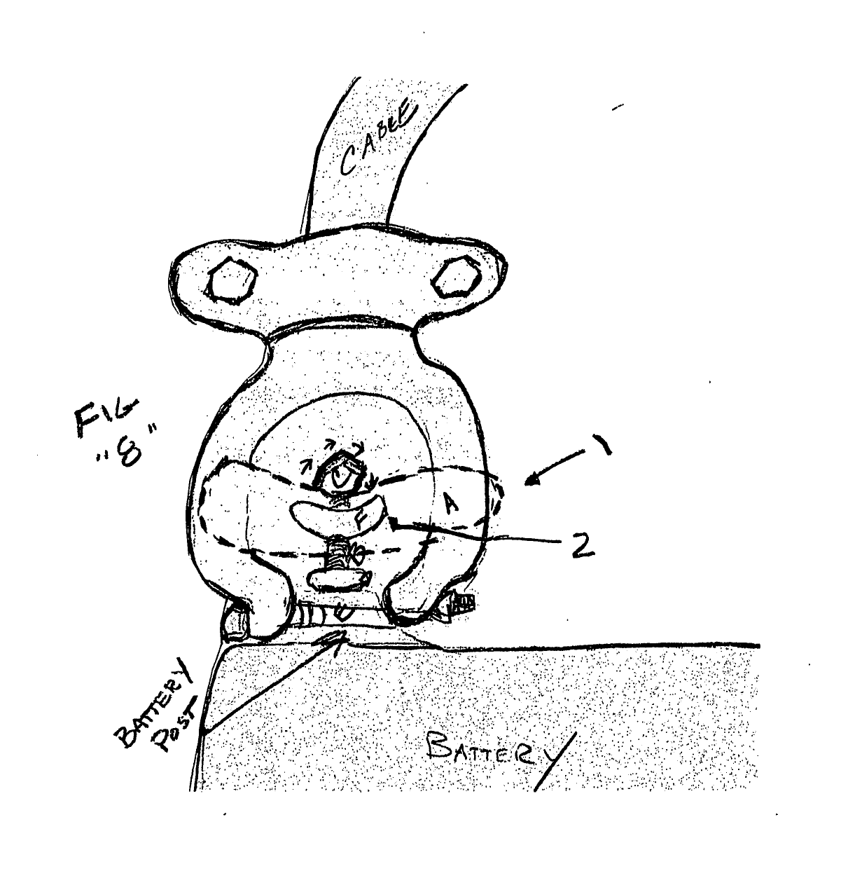

FIG. 6 is a much larger top view of the battery cable end used for description, also viewed as sheet 6 of 8 is a large top view of the battery cable end for reference.

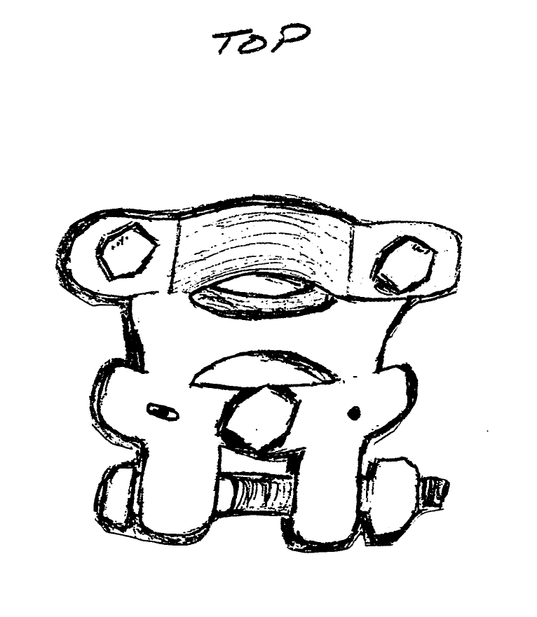

FIG. 7 is a much larger bottom view of the battery cable end used for description, also viewed as sheet 7 of 8 is a large bottom view of the battery cable end for reference.

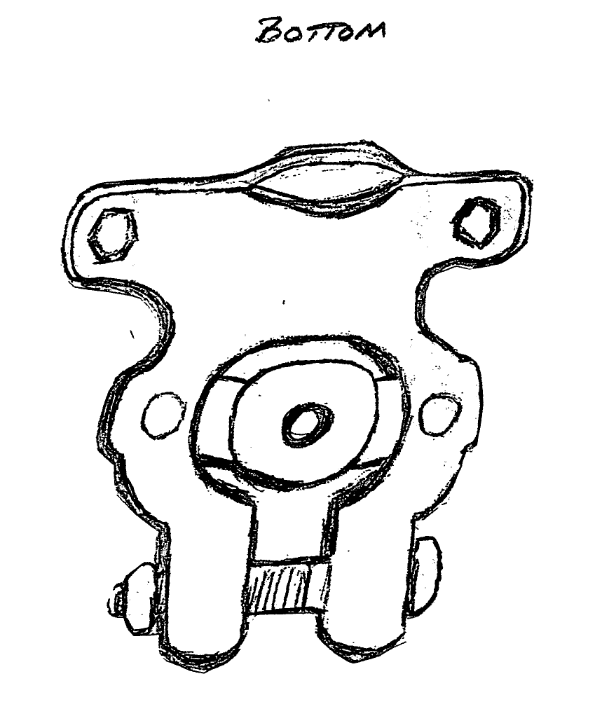

FIG. 8 shows how the addition of the E-Z PULL BATTERY TERMINAL helps remove the cable end without damaging the post or battery.

### DESCRIPTION OF A PREFERRED EMBODIMENT OF THE INVENTION

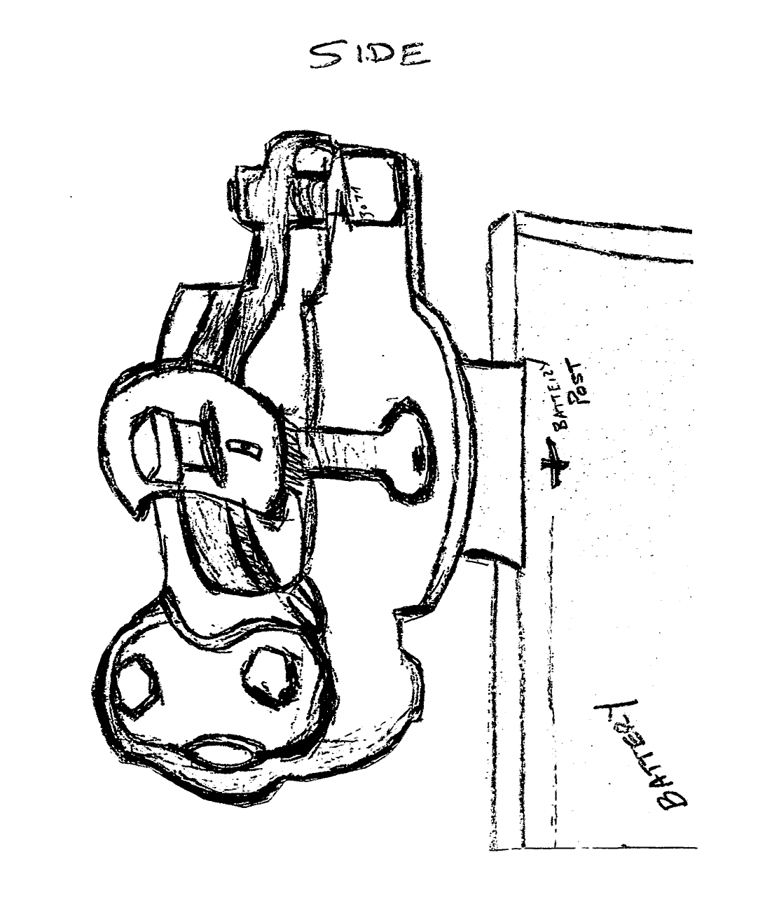

Referring to drawings, FIG. 8 shows a three dimensional battery cable end 1 that has been modified with a removal system that has been designed to operate with various tools, e.g., an end wrench, socket and ratchet, pliers and various other hand tools. This modified battery cable end may be used in cars, trucks, semi-trucks, motorhomes, forklifts, golf carts and other areas where batteries are utilized.

Battery cable end 1 has been modified to retain the patent modification by adding the removal mechanism 2 that is affixed to the battery cable. Mechanism 2 is a flat plate surface A that mounts on top of cable 1 approximately ¼ inch above where the battery post pushes through top of cable 1. Surface A will have a threaded device or push rod B that will be centered over the top of the battery post which will be manipulated clockwise and counter clockwise by a bolt style head or screw, hex device, star tool, screwdriver, phillips screwdriver or any other hand or power tool. Mounted on the bottom of B, a threaded device or push rod is D, a circular pressure seat so that when the threaded device, push rod is manipulated by C, it will put force in a downward motion against E, the battery post top surface in which 1 battery cable end will be forced upward and remove from battery post. Threaded connect on F is what B threads up and down through.

1. A tool for the removal of battery terminals from the battery post.
